(19) United States
(12) Patent Application Publication
(10) Pub. No.: US 2026/0339947 A1
(43) Pub. Date: Oct. 29, 2026

(54) LLM STRUCTURED DATA PROCESSING

(71) Applicant: INTERNATIONAL BUSINESS MACHINES CORPORATION, ARMONK, NY (US)

(72) Inventors: Arn Hyndman, Ottawa (CA); Michele Crudele, Rome (IT); SIMONE PELLEGRINI, Rome (IT); Demis Serafini, Fiumicino (IT)

(21) Appl. No.: 19/192,286

(22) Filed: Apr. 28, 2025

(51) Int. Cl. G06F 16/2453

(52) U.S. Cl. CPC G06F 16/24542

(57) ABSTRACT

A computer-implemented method and computing device to process structured data includes extracting identifying information and a type information from a user query by an Artificial Intelligence model (AIM). At least one of the extracted identifying information and/or the information type is replaced with placeholders. One or more AIM-supported operations are performed on the user query having the placeholders to generate a response. The response to the user query is output after replacing the placeholders with the originally named identifying information. The identifying information includes extracting entity names from the user query by a large language model (LLM).

### BACKGROUND

### Technical Field

The present disclosure generally relates to Artificial Intelligence models (AIMs), and more specifically, to large language models (LLMs) used with back-end processing to interpret or create structured data.

### Description of the Related Art

In recent years, AIMs have been used increasingly with back-end systems via patterns such as retrieval augmented generation (RAG) and tool calling. In these scenarios, a user prompt may be interpreted by an AIM (or interpreted by an embedding model to create a vector embedding) to look up some structured data or construct some structured data for tool calling.

### SUMMARY

A computer-implemented method, computing device, and a computer program product to enhance a large language model (LLM) processing of structured data. The operations include preprocessing a user query by extracting named entities and type information from the user query, wherein extracting named entities and type information from the user query is performed by an LLM. There is a lookup of the named entities and type information from the user query in another system, such as a database, API, etc., to increase the accuracy of the named entities and type information extracted from the user query. The named entities and type information are replaced with placeholders. LLM or embedding model-supported operations are performed on the user query, and an output is processed to replace the placeholders in the output with the originally named entities and type information.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead of. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 illustrates examples of queries that are to be processed by an AIM, consistent with an illustrative embodiment.

FIG. 2 is a table listing examples of names, types, original terms, and placeholders, consistent with an illustrative embodiment.

FIG. 3 illustrates the queries from FIG. 1 after a named entity extraction operation is performed, consistent with an illustrative embodiment.

FIG. 4 is a flowchart illustrating the operations of the computer-implemented method, consistent with an illustrative embodiment.

FIG. 5 illustrates a block diagram of a computing environment consistent with an illustrative embodiment.

### DETAILED DESCRIPTION

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings.

As used herein, the term “and/or” when referring to two recited elements (e.g., element A, element B) is to be understood to refer to element A alone, element B alone, or elements A and B together.

As used herein, the term “tool calling” refers to artificial intelligence (AI) systems' ability to interact with external tools, application programming interfaces (APIs), or other systems to provide enhanced functionality. AI systems with tool-calling capabilities can query databases, fetch information in real-time, execute functions, or perform complex operations beyond native capabilities. Tool calling permits AI systems to operate without complete reliance on pretrained knowledge.

As used herein, the term “Artificial Intelligence model” (AIM) refers to a computational system that has been trained on a set of data to recognize certain patterns or make certain decisions without further human intervention. An LLM is a specialized type of AI model. While the present disclosure provides examples of structured data processing using an LLM, other AI models may apply the teachings of the present disclosure.

As used herein, the term “AIM-supported operations” refers to performing operations that may include a request for an SQL generation, a retrieval augmented generation (RAG) search request, tool calling, and fetching the placeholders from an application programming interface (API). An LLM may perform the AIM model-supported operations.

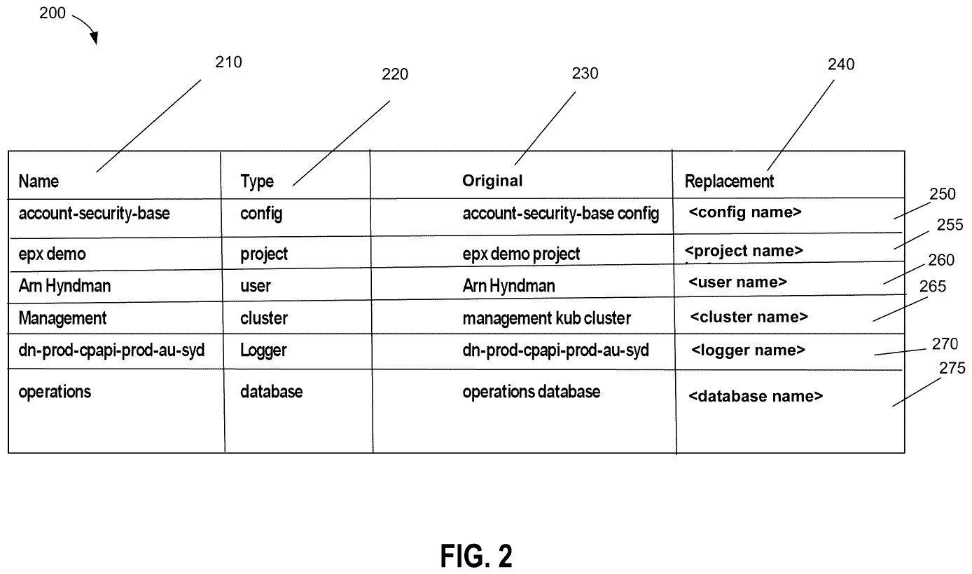

As used herein, the term “type” refers to a category of the underlying object. For example, “Rex” is of the type “Dog” and “Mary” is of the type “person”. In another example, an entity name information in a query (e.g., “epx demo”) may have an associated type. The type information in this example associated with “epx demo” is a project (the type of the underlying object being a project). Type information associated with entity name information may include, but is not limited to, config, user, cluster, logger, such as shown in FIG. 2.

### Overview

While AIMs are increasing in use in many applications, it is known that AIMS (such as LLMs) tend to interpret names to have meaning even in cases where such interpretation is unwarranted or undesired. For example, if a user's query to find the correct table to store company names and addresses happens to include an example company name such as “Joe's Billing and Accounting”, the LLM/embedding model may return billing or accounting-related tables instead. This drawback in using LLMs sometimes occurs when working with structured data, and there may be difficulty in detecting and debugging such errors because identical queries with other names may work perfectly. The result is that AI agents/LLM-powered software can be unreliable in ways that are subtle, difficult to predict, and difficult to address.

According to one or more embodiments of the present disclosure, a computer-implemented method and computing device process user queries by executing an entity extraction operation that leverages a prompted LLM call. Entity extraction can be performed by a prompted LLM, or by a prompted and fine-tuned LLM, or even by a specifically trained model. Named entities are replaced with placeholders that disclose the entity type without the actual names. The name is removed and replaced by generic type information. In one non-limiting example, a name “Joe's Billing and Accounting” becomes “<company name>” and the processed query is provided to the LLM for a plurality of different types of operations, including but not limited to tool calling and/or vector embedded generation to generate a response to the query. It is to be understood that other kinds of placeholders may be used other than placeholders formatted as <type+name>.

The computer-implemented method and computing device according to embodiments of the present disclosure ensure that “distracting names” are replaced with abstract names so the LLM does not produce inaccurate query results.

In the illustrated embodiments presented herein, the implementation uses an AIM, such as a prompted general purpose LLM. However, it is to be understood that it is to be understood that the appended claims are not limited to being practiced with an LLM, and may be practiced with a specifically trained model, which may be more efficient if the process is to be run a very large number of times.

### Technical Advantages and Support

The computer-implemented method and computing device provide an improvement in the accuracy of AIM operations, including but not limited to tool calling and vector embedded generation. There is also an improvement in computer operations because of increased efficiency based on the enhanced accuracy of the processing of structured data. Additional benefits include an increase in the AI agents behaving predictably while preserving the ability to process arbitrarily-generated human queries. The computer-implemented method may be achieved even with smaller, low-cost models with increased reliability over conventional LLM processing of structured data.

Another benefit of the computer-implemented method and computing device of the present disclosure is improved security. Through the use of placeholder replacements of names, the possibility of potentially sensitive information being sent to the LLM is avoided. In addition, there is a dimension of hacking with large language models referred to as “prompt injection,” where a query is injected by the hacker that causes the LLM to perform some type of operation that is not desired by the owner of the software. The use of placeholders may eliminate a whole class of prompt injection attacks.

In an embodiment, a computer-implemented method to process structured data includes extracting identifying information and a type information from a user query by an Artificial Intelligence model (AIM). At least one of the extracted identifying information and/or the type information is replaced with placeholders. One or more AIM-supported operations are performed on the user query having the placeholders that are used to generate a response to the user query. The generated response to the user query is output after replacing the placeholders with the identifying information and/or the type information originally extracted by the LLM.

In an embodiment, which may be combined with the preceding embodiment, the extracting of identifying information includes extracting entity names from the user query by a large language model (LLM).

In an embodiment, which may be combined with one or more of the preceding embodiments, at least one data source is searched. The data source may be searched for a number of reasons, such as to supply a type of data altogether for cases when the type cannot be inferred from the user query. Moreover, the system may prompt the user to supply the type of data rather than search a data source. Alternatively or in addition, the data source may be searched to verify the accuracy of the extracted identifying information and the extracted type information before replacement with the placeholders.

In an embodiment, which may be combined with one or more of the preceding embodiments, the searching of the at least one data source includes searching a reference data set.

In an embodiment, which may be combined with one or more of the preceding embodiments, the placeholders are generated based on types of identifying information, and the placeholders are stored in a database.

In an embodiment, which may be combined with one or more of the preceding embodiments, the generated placeholders are retrieved from a database.

In an embodiment, which may be combined with one or more of the preceding embodiments, the placeholders are generated based on types of identifying information obtained from an application programming interface (API).

In an embodiment, which may be combined with one or more of the preceding embodiments, the one or more AIM-supported operations include performing a tool call.

In an embodiment, which may be combined with one or more of the preceding embodiments, the one or more AIM-supported operations include performing a request for SQL generation.

In an embodiment, which may be combined with one or more of the preceding embodiments, the one or more AIM-supported operations include performing a retrieval augmented generation (RAG) search request.

one embodiment, a computing device to process structured data includes a processor and a storage device coupled to the processor. The storage device stores instructions to cause the processor to perform acts, including extracting identifying information and a type information from a user query by a large language model (LLM). At least one of the extracted identifying information and/or the extracted type information is replaced with placeholders. One or more of the LLM model-supported operations are performed on the user query, having the placeholders. The response to the user query is output after replacing the placeholders with the identifying information and/or the type information originally extracted from the query prior to performing the LLM model-supported operations.

In an embodiment, which may be combined with the preceding embodiment, the instructions cause the processor to perform an additional act including searching at least one data source to verify the accuracy of the extracted identifying information and the information type before replacement with the placeholders.

In an embodiment, which may be combined with one or more of the preceding embodiments, the instructions cause the processor to perform an additional act including extracting names from the user query.

In an embodiment, which may be combined with one or more of the preceding embodiments, the instructions cause the processor to perform an additional act of verifying the accuracy of the extracted identifying information and the type information with a data source before replacement with the placeholders.

In an embodiment, which may be combined with one or more of the preceding embodiments, the instructions cause the processor to perform an additional act of using a reference data set as the data source to verify the accuracy of the extracted identifying information and the information type.

In an embodiment, which may be combined with one or more of the preceding embodiments, the instructions cause the processor to perform an additional act of retrieving the placeholders from a storage table.

In an embodiment, which may be combined with one or more of the preceding embodiments, the instructions cause the processor to perform an additional act of retrieving the placeholders from a database.

In an embodiment, which may be combined with one or more of the preceding embodiments, the instructions cause the processor to perform an additional act of retrieving the placeholders from an application programming interface (API).

In an embodiment, which may be combined with one or more of the preceding embodiments, the one or more AIM-supported operations include performing a tool call.

In an embodiment, which may be combined with one or more of the preceding embodiments, the one or more AIM-supported operations include a request for an SQL generation and/or a retrieval augmented generation (RAG) search request.

In one embodiment, a computer program product (CPP) includes one or more computer-readable storage media, and program instructions collectively stored on the one or more computer-readable storage media. An execution of the program instructions by a computing device cause the computing device to perform acts including extract entity name information and a type information from a user query by a large language model (LLM); replace at least one of the extracted name information and/or the type information with placeholders; perform one or more LLM model-supported operations on the user query having the placeholders to generate a response; and output the generated response to the user query after replacing the placeholders with the entity named information and/or the type information originally extracted by the LLM.

### Example Embodiment(s)

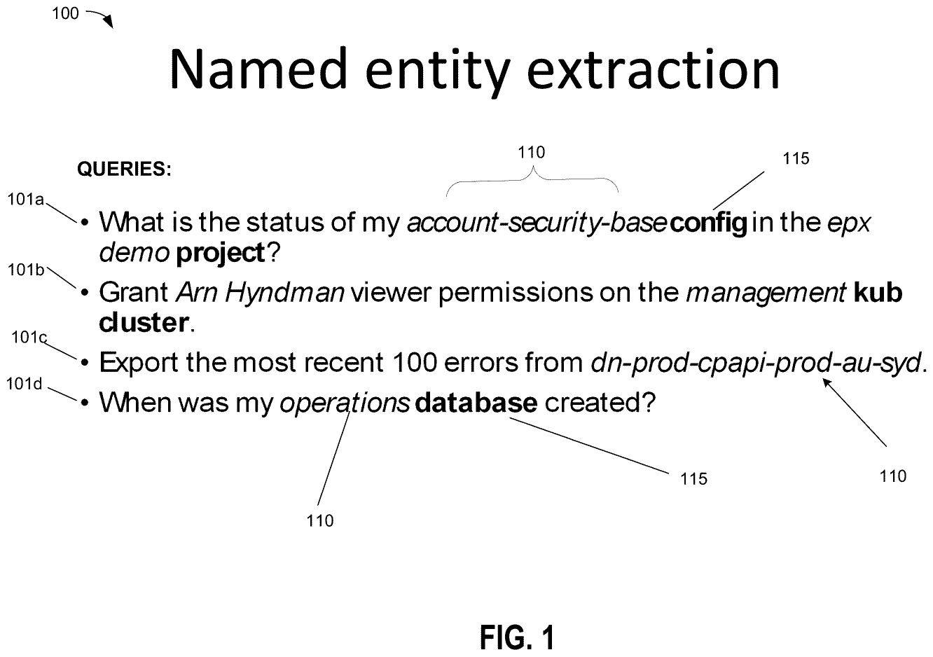

FIG. 1 is an illustration 100 listing examples of queries that are to be processed by an LLM, consistent with an illustrative embodiment. There are examples of several different queries, 101a, 101b, 101c, and 101d, that may be received from a user. It is to be understood that the queries could be requests for SQL generation, retrieval, augmented generation (RAG) searches, etc.

The queries may contact names, types, or both. For example, query 101a has both a name 110 and a type 115. Queries 101b and 101d also have a name 110 and a type 115. However, query 101c has only a name 110 without a type 115. The names 110 and types 115 in each of the queries 101a, 101b, and 101d are identified for extraction. An additional operation may be performed with regard to query 101c to provide a type 115.

FIG. 2 is a table 200 listing examples of names, types, original terms, and placeholders, consistent with an illustrative embodiment. Referring now to FIG. 2, there are columns shown for the identified name 210, identified type 220, original term 230, and replacement (placeholder) 240. The original terms 230 are the terms shown in queries 101a, 101b, 101c, and 101d shown in FIG. 1. Each query is searched, and when a name 110 is found, it is listed as an identified name 210 on the labeled column of the table 200 in FIG. 2.

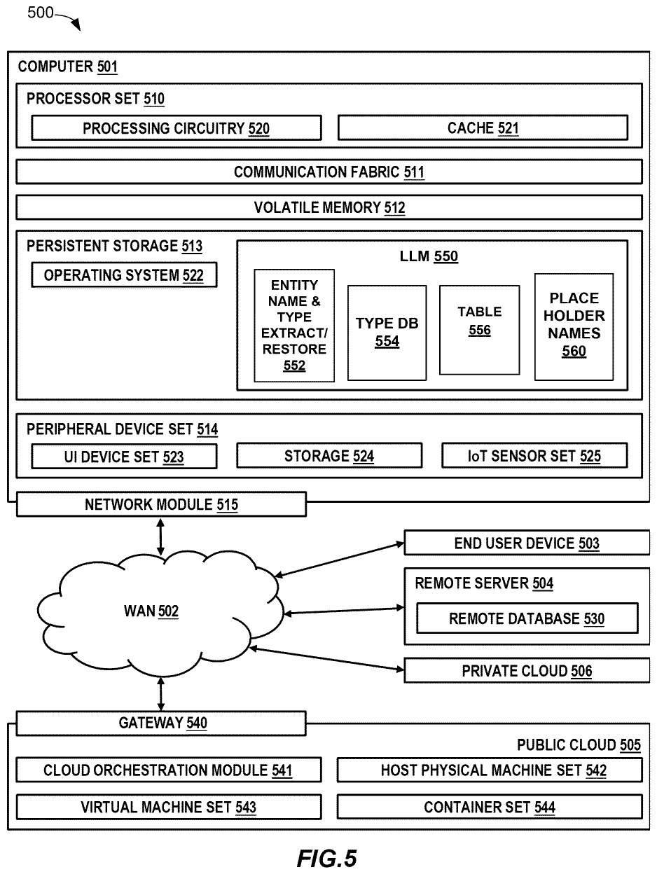

With continued reference to FIGS. 1 and 2, the queries 101a, 101b, 101c, 101d are searched for a type 115. If a type 115 is found, it is stored in table 200 as an identified type 220. In the case where only a name is found, a type database (see FIG. 5) may be searched to check whether the type identified with the name in the query may be stored in the table, or a query back to the user request the type. For example, FIG. 1, shows that query 101c lists a name, and the type database may be searched to identify a type. The identified type 220 may then be added to the table 200.

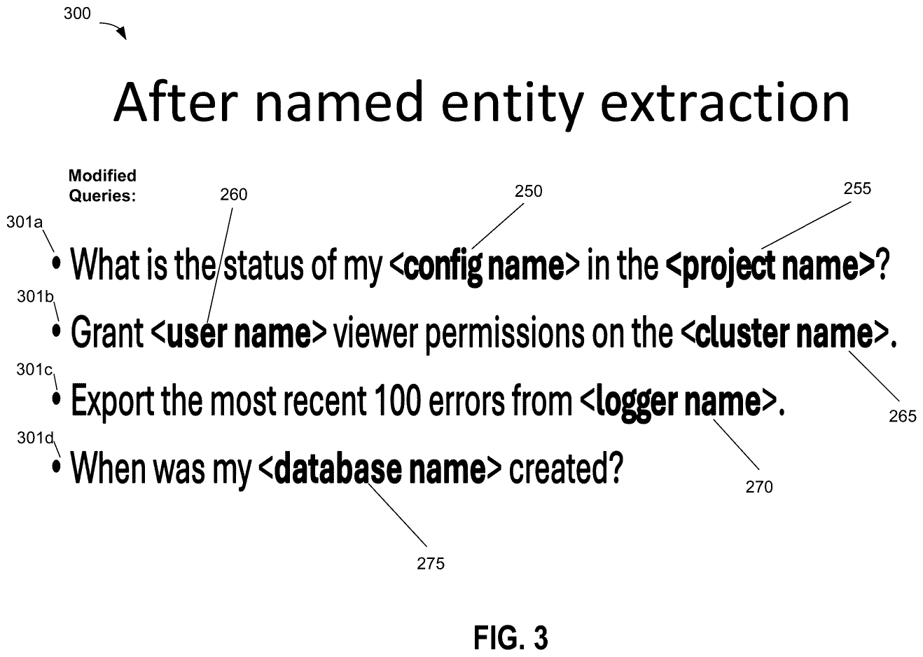

FIG. 3 is a depiction 300 of the queries from FIG. 1 after a named entity extraction operation is performed, consistent with an illustrative embodiment. Queries 301a, 301b, 301c, and 301d shown in FIG. 3 are modified versions of queries 101a, 101b, 101c, and 101d, respectively, as shown in FIG. 1. For example, in query 301a the terms “<config name>” 250 and “<project name>” 255 are used as placeholders in the status request query 101a shown in FIG. 1. In query 301b, the terms “<user name>” 260 and “<cluster name>” 265 are used as placeholders in the viewer permission query 101b shown in FIG. 1. In query 301c, the term “<logger name>” is used as a placeholder in the export errors query 101c shown in FIG. 1. In query 301d, the term “<database name>” 275 is used as a placeholder in the operations data query 101d shown in FIG. 1.

At least one of the modified queries is used for an LLM call (e.g. SQL generation, RAG search, etc.). It is to be understood that the LLM call is not limited to SQL generation or RAG searches, which are provided here for explanatory purposes.

### Example Process

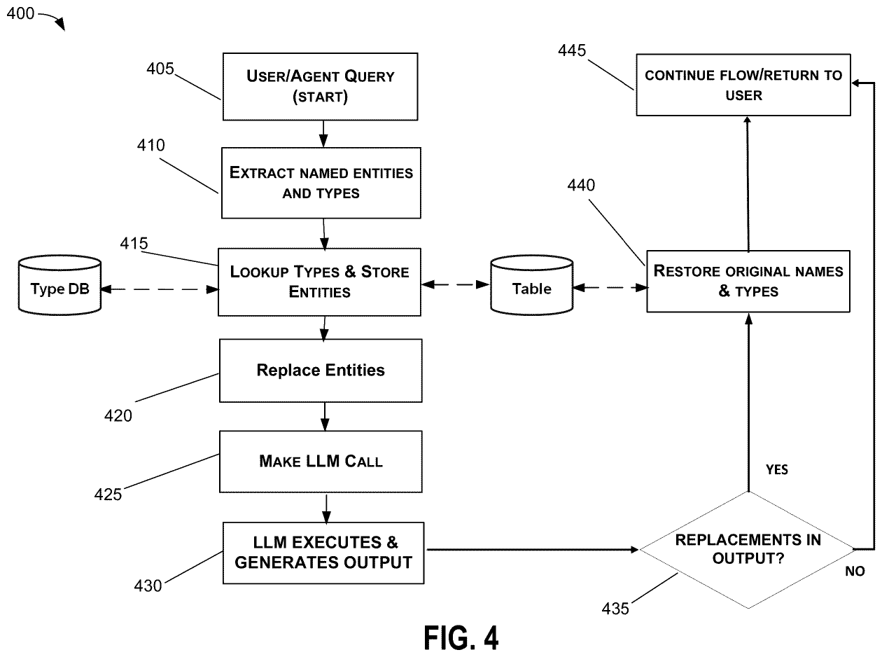

With the foregoing description of an overview and example embodiment, it may be helpful now to consider a high-level discussion of an example computer-implemented process. To that end, FIG. 4 is a flowchart 400 illustrating a computer-implemented method of LLM structured data processing consistent with an illustrative embodiment in conjunction with one or more of FIGS. 1 to 3. FIG. 4 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

The computer-implemented method may start when a query is received from a user/agent (operation 405). The query is not limited in scope in terms of scope and may be autogenerated, or by a person. Queries 101a, 101b, 101c, and 101d are some non-limiting examples of queries that may be received.

The received query is checked for entities and types (operation 410). A language processing module may check the query for named entities and types. An LLM may perform the extraction of the named entities and types. As shown in FIG. 1, the names 110 of entities and types 115 are extracted at operation 410, and stored (operation 415). Prior to storing, if the query was identified as having a name 110 of an entity but did not have a type, a type DB (see also FIG. 5) may be checked to find a corresponding type that is stored in a table. It should be understood that while storage in a table is disclosed in this illustrative embodiment, the computer-implemented method is not limited to table storage.

The extracted names of entities are replaced with placeholders (operation 420). FIG. 2 shows examples of replacement placeholders 240 that may include config name 250, project name 255, user name 260, cluster name 265, logger name 270, and database name 275.

The LLM call is made by sending the modified query (such as shown in FIG. 3 by examples of modified queries 301a-301d) using placeholders for entity names (and optionally types (operation 425)). The LLM call may be a tool call, a request for SQL generation, or an RAG search request, etc., based on the modified user query, to provide some non-exhaustive examples.

A response to the query is generated based on the data obtained by the LLM call. (operation 430). In other words, the tool call, SQL query RAG search request, or whatever request that was made to the LLM is executed (that may use conventional code) to respond to the modified user query (e.g., query with placeholders). An output is generated by the LLM.

It is then determined, after the output is received, whether there are placeholders in the output (operation 435). If the determination at operation 435 is that placeholders are in the output, then the original entity names and types are restored (operation 440). The table may be used to obtain the original names 110 and types 115.

The generated response to the query is output/provided to the user to continue the workflow (operation 445) after the placeholders are restored (or in the case where there were no placeholders in the LLM's output). Thus, through the use of the modified queries, the computer-implemented method and computing device according to the present disclosure provide an enhancement in the accuracy of LLM operations, and an enhanced security by reducing/eliminating the use of prompt injections by hackers.

### Computer Program Product

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

### Computing Environment

FIG. 5 illustrates a block diagram of a computing environment consistent with an illustrative embodiment.

With reference to FIG. 5, the computing environment 500 includes an example of an environment for the execution of at least some of the computer code involved in performing the inventive methods. In an embodiment, computer executable instructions performed a computer-implemented method of processing structured data. An LLM 550 includes a processor such as a GPU (or a CPU) with access to RAM and GPU VRAM (Video RAM) to store model weights and data during processing. Storage modules, such as an entity name information and type information extraction/restoration module 552, operates to identify and extract an entity name and a type (if present) and store the information in a table 556. There is also a restoration operation of the entity name in a generated response to a query prior to being output to the user. As discussed in an embodiment above, if an entity name is identified in a query without a type, then a type database 554 may be searched to identify a type associated with the identified entity name used in a query. A placeholder names module 560 operates to provide designated placeholder names for various parts of the query including but not limited to a config name 250, project name 255, user name 260, cluster name 265, logger name 270, database name 275 (shown in FIG. 2).

In addition, computing environment 500 includes, for example, computer 501, wide area network 502 (WAN), end user device 503 (EUD), remote server 504, public cloud 505, and private cloud 502. In this embodiment, computer 501 includes processor set 510 (including processing circuitry 520 and cache 521), communication fabric 511, volatile memory 512, persistent storage 513 (including operating system 522 and large language model (LLM) 550, as identified above), peripheral device set 514 (including user interface (UI) device set 523, storage 524, and Internet of Things (IOT) sensor set 525), and network module 515. Remote server 504 includes remote database 560. Public cloud 505 includes gateway 540, cloud orchestration module 541, host physical machine set 542, virtual machine set 543, and container set 544.

Computer 501 may take the form of a server, desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically Computer 501, to keep the presentation as simple as possible. Computer 501 may be located in a cloud, even though it is not shown in a cloud in FIG. 5. On the other hand, Computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto Computer 501 to cause a series of operational steps to be performed by processor set 510 of Computer 501 and thereby effect a computer-implemented method, such that the instructions thus executed instantiates the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in persistent storage 513.

Communication fabric 511 is the signal conduction path that allows the various components of Computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, volatile memory 512 is characterized by random access, but this is not required unless affirmatively indicated. In Computer 501, the volatile memory 512 is located in a single package and is internal to Computer 501, but, alternatively or additionally, the volatile memory may be distributed over multiple packages and/or located externally with respect to Computer 501.

Persistent storage 513 is any form of non-volatile storage for computers that is now known or to be developed in the future. The non-volatility of this storage means that the stored data is maintained regardless of whether power is being supplied to Computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface-type operating systems that employ a kernel. The code included in the persistent storage 513 typically includes at least some of the computer code involved in performing the inventive methods.

Peripheral device set 514 includes the set of peripheral devices of Computer 501. Data communication connections between the peripheral devices and the other components of Computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where Computer 501 is required to have a large amount of storage (for example, where Computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows Computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to Computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 503 is any computer system that is used and controlled by an end user (for example, a customer of an enterprise that operates Computer 501) and may take any of the forms discussed above in connection with Computer 501. EUD 503 typically receives helpful and useful data from the operations of Computer 501. For example, in a hypothetical case where Computer 501 is designed to provide a recommendation to an end user, this recommendation would typically be communicated from network module 515 of Computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to Computer 501. Remote server 504 may be controlled and used by the same entity that operates Computer 501. Remote server 504 represents the machine(s) that collect and store helpful and useful data for use by other computers, such as Computer 501. For example, in a hypothetical case where Computer 501 is designed and programmed to provide a recommendation based on historical data, then this historical data may be provided to Computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to better explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

1. A computer-implemented method of a system to process structured data, the computer-implemented method comprising:
extracting identifying information and a type information from a user query by an Artificial Intelligence model (AIM);
replacing with placeholders at least one of the extracted identifying information or the type information;
performing one or more AIM-supported operations on the user query having the placeholders to generate a response; and
outputting, from the system to a user, the generated response to the user query after replacing the placeholders with the identifying information or the type information originally extracted by the AIM.

2. The computer-implemented method according to claim 1, wherein the extracting identifying information includes extracting entity names from the user query by a large language model (LLM).

3. The computer-implemented method according to claim 2, further comprising:
prior to replacing with the placeholders, searching at least one data source to obtain the type information when the type information is not provided in the user query.

4. The computer-implemented method according to claim 3, wherein searching of the at least one data source includes searching a reference data set.

5. The computer-implemented method according to claim 1, further comprising:
prompting a user to provide the type information when the type information is not provided in the user query.

6. The computer-implemented method according to claim 1, further comprising generating the placeholders based on types of the identifying information, and storing the placeholders in a storage table.

7. The computer-implemented method according to claim 1, further comprising generating the placeholders based on types of the identifying information, and storing the placeholders in a database.

8. The computer-implemented method according to claim 1, further comprising generating the placeholders based on types of the identifying information obtained from an application programming interface (API).

9. The computer-implemented method according to claim 1, wherein the one or more AIM-supported operations includes performing a tool call or a request for SQL generation.

10. The computer-implemented method according to claim 1, wherein the one or more AIM-supported operations includes performing a retrieval augmented generation (RAG) search request.

11. A computing device to process structured data, the computing device comprising:
a processor;
a storage device coupled to the processor;
the storage device storing instructions to cause the processor to perform acts comprising:
extracting identifying information and a type information from a user query by an Artificial Intelligence model (AIM);
replacing the extracted identifying information and the extracted type information with placeholders;
performing one or more AIM-supported operations on the user query having the placeholders to generate a response; and
outputting, from the computing device to a user, the generated response to the user query after replacing the placeholders with the identifying information or the type information originally extracted by the AIM.

12. The computing device according to claim 11, wherein the instructions cause the processor to perform an additional act comprising searching at least one data source to obtain the type information when not provided in the user query prior to replacement with the placeholders.

13. The computing device according to claim 12, wherein the instructions cause the processor to perform additional acts comprising:
extracting entity names from the user query by a large language model (LLM), and wherein performing of the one or more AIM-supported operations includes a request for an SQL generation or a retrieval augmented generation (RAG) search request.

14. The computing device according to claim 13, wherein the instructions cause the processor to perform an additional act comprising verifying an accuracy of the extracted identifying information prior to replacement with the placeholders.

15. The computing device according to claim 14, wherein the instructions cause the processor to perform an additional act comprising using a reference data set as the data source to obtain the type information when not provided in the user query.

16. The computing device according to claim 11, wherein the instructions cause the processor to perform an additional act comprising prompting a user to provide the type information when the type information is not provided in the user query.

17. The computing device according to claim 11, wherein the instructions cause the processor to perform additional acts comprising:
generating the placeholders based on types; and
storing the placeholders in a storage table.

18. The computing device according to claim 11, wherein the instructions cause the processor to perform additional acts comprising:
generating the placeholders based on types; and
storing the placeholders in a database.

19. The computing device according to claim 11, wherein the instructions cause the processor to perform additional acts comprising generating the placeholders based on types obtained from an application programming interface (API).

20. A computer program product to process structured data of a system, the computer program product comprising one or more computer-readable storage media, and program instructions collectively stored on the one or more computer-readable storage media, wherein an execution of the program instructions by a computing device causes the computing device to perform acts comprising:
extract entity name information and a type information from a user query by a large language model (LLM);
replace the extracted entity name information or the type information with placeholders;
perform one or more LLM model-supported operations on the user query having the placeholders to generate a response; and
output, from the system to a user, the generated response to the user query after replacing the placeholders with the entity named information or the type information originally extracted by the LLM.
